(19) United States
(12) Patent Application Publication
(10) Pub. No.: US 2024/0193355 A1
(43) Pub. Date: Jun. 13, 2024

(54) INFORMATION PROCESSING APPARATUS, CONTROL METHOD THEREOF, AND STORAGE MEDIUM

(71) Applicant: CANON KABUSHIKI KAISHA, Tokyo (JP)

(72) Inventor: MASASHI YURI, Chiba (JP)

(21) Appl. No.: 18/527,653

(22) Filed: Dec. 4, 2023

(30) Foreign Application Priority Data
Dec. 7, 2022 (JP) 2022-195863

(51) Int. Cl. G06F 40/171; G06T 7/00

(52) U.S. Cl. CPC G06F 40/171; G06T 7/0006

(57) ABSTRACT

The present invention is directed to an information processing apparatus comprising: at least one memory device that stores a set of instructions; and at least one processor that executes the set of instructions to: inspect a line width of an object included in print data after image processing is applied on input data for printing, and correct a line width of the object based on an inspection result.

### BACKGROUND OF THE INVENTION

### Field of the Invention

The present invention relates to an information processing apparatus, a control method thereof, and a storage medium.

### Description of the Related Art

In recent years, along with the spread of Personal Computers (PCs) and development of relevant techniques, digital submission using a PC is becoming widespread in commercial printing. For digital submission, Portable Document Format (PDF) is a generally used data format. Printing companies that print submitted PDF data as a print job preliminarily perform preflight inspection on the print result. The purpose thereof is to prevent increase of waste paper or rework time that may occur when processing or correction of the print job is needed in a case where a problem is revealed after printing is executed.

In Japanese Patent Laid-Open No. 2005-085180, it is proposed to inspect the quality of the reproduced state of a print product image before execution of print data processing. In this inspection, Raster Image Processor (RIP) processing or screen processing is simulated and inspection is performed whether or not a determination condition is satisfied, based on feature amounts extracted from various objects included in the print job.

However, the conventional technology described above has a problem described below. For the PDF, which is a format generally used in submission, RIP processing based on PostScript (referred to as PS in the following) is applied. When lines are printed with RIP processing of PS, although drawing commands specify the line width to be same before the RIP processing, variation may occur such that the thickness of lines drawn after the RIP processing are different, depending on whether or not the coordinates of the line instructed to be drawn is laying across the dots. However, the conventional technique described above cannot inspect the variation of the line width of after the RIP processing. In addition, there is a problem that an inspection result is only notified, and a performer of preflight inspection does not know how to handle the inspection result.

### SUMMARY OF THE INVENTION

The present invention enables realization of a mechanism for appropriately inspecting variation of line width after image processing is applied on input data.

One aspect of the present invention provides an information processing apparatus comprising: at least one memory device that stores a set of instructions; and at least one processor that executes the set of instructions to: inspect a line width of an object included in print data after image processing is applied on input data for printing, and correct a line width of the object based on an inspection result.

Another aspect of the present invention provides a control method for an information processing apparatus, comprising: inspecting a line width of an object included in print data after image processing is applied on input data for printing; and correcting a line width of the object based on an inspection result.

Still another aspect of the present invention provides a non-transitory computer-readable storage medium storing a computer program for causing a computer to execute each step in a control method of an information processing apparatus, the control method comprising: inspecting a line width of an object included in print data after image processing is applied on input data for printing; and correcting a line width of the object based on an inspection result by the inspecting.

The present invention is, for example, an information processing apparatus including an inspection unit configured to inspect a line width of an object included in print data after image processing is applied on input data for printing, and a correction unit configured to correct the line width of the object, based on an inspection result by the inspection unit.

Further features of the present invention will be apparent from the following description of exemplary embodiments with reference to the attached drawings.

### BRIEF DESCRIPTION OF THE DRAWINGS

FIG. 1 is a diagram illustrating a configuration example of an entire printing system according to an embodiment;

FIG. 2 is a diagram illustrating an example of a printing processing sequence according to an embodiment;

FIG. 3 is a diagram illustrating an example of an inspection/correction setting screen according to an embodiment;

FIG. 4 is a flowchart illustrating a series of processing procedures of an information processing apparatus according to an embodiment;

FIG. 5 is a flowchart illustrating details of a processing procedure of line width variation inspection/correction processing (S207) according to an embodiment;

FIG. 6 is a diagram illustrating an example of a configuration of PDF data, a configuration of intermediate data, and an RIP display result according to an embodiment;

FIGS. 7A-7B are a diagram illustrating an example of line width variation correction according to an embodiment; and

FIG. 8 is a diagram illustrating an example of an inspection/correction result screen according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### <Configuration of Printing System>

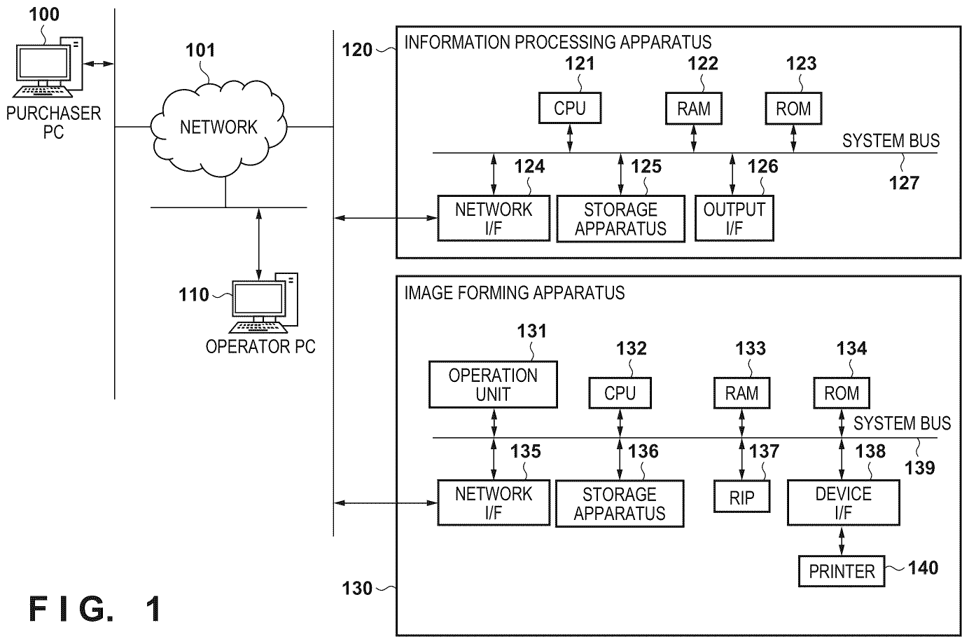

An embodiment of the present invention will be described below. First, a configuration example of an entire printing system according to the present embodiment will be described, referring to FIG. 1. The system includes a purchaser PC 100, an operator PC 110, an information processing apparatus 120, and an image forming apparatus 130.

The purchaser PC 100 is used by a purchaser to create PDF data to be submitted and order printing to a printing company. The operator PC 110 is used by an operator to check inspection settings, inspection results, and correction results. The information processing apparatus 120 receives the PDF data to be submitted as a print job, and applies inspection and correction processing. The image forming apparatus 130 executes a printing processing in accordance with the print job. Each of the apparatuses is connected via a network 101 connected by a network such as a Wide Area Network (WAN). Here, the image forming apparatus 130 may be any of printers such as a Multi Function Printer (MFP), a Single Function Printer (SFP), and a Laser Beam Printer (LBP). Alternatively, The image forming apparatus 130 may employ a printing method other than MFP, SFP, and LBP.

Next, details of the hardware configuration of the information processing apparatus 120 will be described. The information processing apparatus 120 includes a CPU 121, a RAM 122, a ROM 123, a network I/F 124, a storage apparatus 125, and an output I/F 126. Each device can exchange data with each other via a system bus 127. The CPU 121 is a central processing unit configured to control the entire information processing apparatus. The RAM 122 is a system work memory for operation of the CPU 121. The ROM 123 is a memory storing programs and the like for executing analysis, inspection, and correction of the system and print jobs.

The network I/F 124 is an interface configured to input and output information from and to the purchaser PC 100, the operator PC 110, and the image forming apparatus 130 via the network 101. The storage apparatus 125 is a hard disk drive (HDD), which serves as a large-capacity storage apparatus that stores system software for various processing, received print jobs, inspection settings, or the like. The output I/F 126 is an interface configured to output inspection results or correction results of print jobs as electronic files or image data.

Next, details of the hardware configuration of the image forming apparatus 130 will be described. The image forming apparatus 130 includes an operation unit 131, a CPU 132, a RAM 133, a ROM 134, a network I/F 135, a storage apparatus 136, a RIP 137, and a device I/F 138. Each device can exchange data with each other via a system bus 139. In addition, a printer 140, which is an image output device, is connected via the device I/F 138. The operation unit 131 is a display screen that can display various menu screens, print data information, or the like. The CPU 132 is a central processing unit configured to control the entire image forming apparatus. The RAM 133 is a system work memory for operation of the CPU 132. The ROM 134 is a memory storing programs and the like for executing analysis, inspection, and correction of the system and print jobs.

The network I/F 135 is an interface configured to input and output information from and to the information processing apparatus 120 via the network 101. A storage apparatus 136 is an HDD, which serves as a large-capacity storage apparatus that stores programs for various processing and received print jobs. The RIP 137 is a processing unit that analyzes intermediate data (display list) required for bitmap generation, which is generated based on the PDF data, and renders bitmap data. The device I/F 138 is an interface configured to connect the image forming apparatus 130 and the printer 140.

Here, in the present embodiment, an embodiment is described in which line width variation inspection and correction is performed in the information processing apparatus 120, it is not intended to limit the present invention thereto. For example, inspection and correction may be executed in the image forming apparatus 130, in which case a program for executing inspection and correction may be stored in the ROM 134.

### <Printing Processing Sequence>

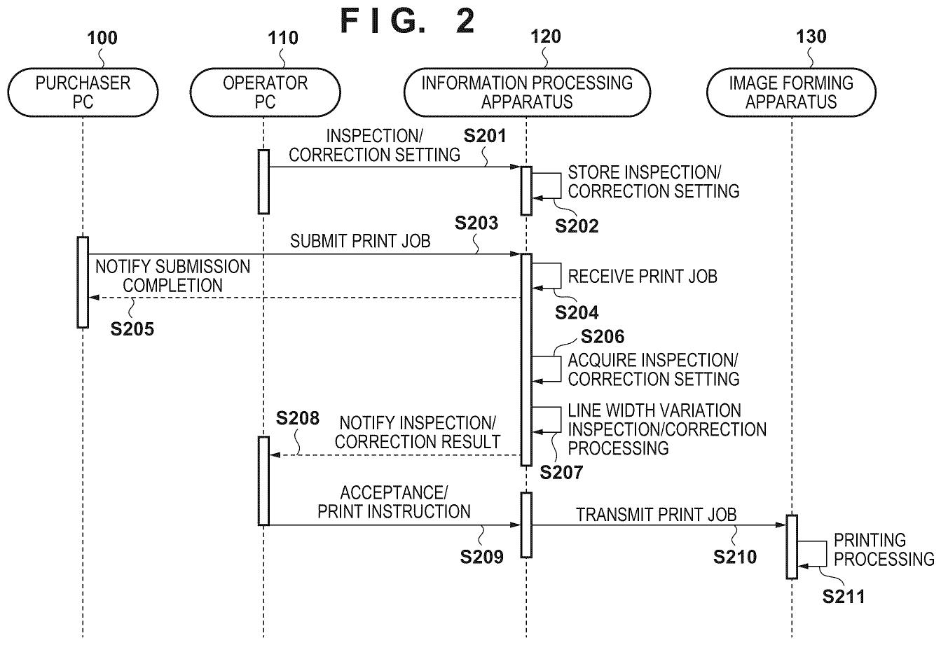

Next, a sequence of the printing processing in the system according to the present embodiment will be described, referring to FIG. 2. Here, a control flow through the purchaser PC 100, the operator PC 110, the information processing apparatus 120, and the image forming apparatus 130 will be described. However, the present invention is not limited thereto and the embodiment may include another apparatus that interposes in the flow, or may employ a plurality of apparatuses being integrated together. For example, the purchaser PC 100 and the operator PC 110 may be a same PC. Alternatively, an apparatus may be provided in which the information processing apparatus 120 and the image forming apparatus 130 are integrated together.

First, at S201, the operator PC 110 performs setting related to inspection and correction for the information processing apparatus 120. At S202, the information processing apparatus 120 stores the setting related to the inspection and correction. Subsequently, at S203, the purchaser PC 100 submits a print job to the information processing apparatus 120. The information processing apparatus 120 receives the submitted print job at S204, and notifies the purchaser PC of submission completion at S205.

Upon notifying the submission completion, the information processing apparatus 120 acquires, at S206, the stored setting related to the inspection and correction, and executes line width variation inspection and correction processing at S207. After executing the inspection and correction processing, the information processing apparatus 120 notifies the operator PC 110 of the inspection and correction result at S208. Upon receiving the notification of the inspection and correction result, the operator PC 110 notifies the information processing apparatus 120 of acceptance of correction and a print instruction at S209. Upon receiving the print instruction, the information processing apparatus 120 transmits, at S210, the print job received from the purchaser PC 100 to the image forming apparatus 130. Finally, at S211, the image forming apparatus 130 executes printing processing in accordance with the received print job, and the current sequence is terminated.

The sequence illustrated in FIG. 2 presents an example of accepting the correction result when the inspection is No Good (NG). However, a case different from the example of FIG. 2 may be allowable, such that, for example, when the inspection is OK, a print job may be transmitted to the image forming apparatus 130 without notifying the operator PC 110 of the result. In addition, the information processing apparatus 120 may execute re-correction in a case where an operator is not satisfied with the correction result when the inspection is NG, or in a case where correction cannot be performed. Alternatively, the information processing apparatus 120 may transmit the input data to the purchaser PC 100 and prompt the purchaser PC for correction instruction of the PDF data in order to regenerate the print job. Here, the inspection and correction setting is assumed to be preliminarily performed in the aforementioned example, the inspection and correction setting may be performed for each job after the submission. Furthermore, the information processing apparatus 120 may execute only inspection, and the operator PC 110 may determine whether or not to perform correction. Here, the operator PC 110 determines the inspection result or the correction result to be OK or NG, the purchaser PC 100 may determine the result.

### <Setting Screen Example>

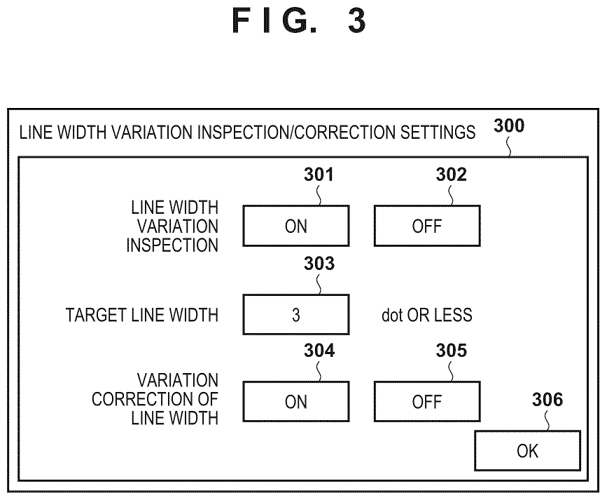

Next, referring to FIG. 3, an example of a setting screen for performing setting of line width variation inspection and correction in the present embodiment will be described. A setting screen 300 illustrated in FIG. 3 is a screen displayed on the display unit of the operator PC 110.

The setting screen 300 includes various buttons 301, 302, 304 to 306 and an area 303. When the ON button 301 is selected by user input, the information processing apparatus 120 executes line width variation inspection. When, on the other hand, the OFF button 302 is selected, the line width variation inspection is not executed. In the area 303, a target line width to be subjected to the inspection and correction processing is specified by a user input. Furthermore, when the ON button 304 is selected by user input, the information processing apparatus 120 executes line width variation correction. When, on the other hand, the OFF button 305 is selected, the line width variation correction is not executed. When the OK button 306 is selected by user input, the information processing apparatus 120 stores the inspection setting in the storage apparatus 125. As such, in the setting screen according to the present embodiment, line width inspection and correction can respectively be set to be enabled or disabled, and a line width to be a target for the inspection and correction processing can also be specified. Here, the setting screen 300 is merely an example, and it is not intended to limit the present invention thereto, and thus other setting items such as setting of allowable value may be included.

### <Processing Procedure by Information Processing Apparatus 120>

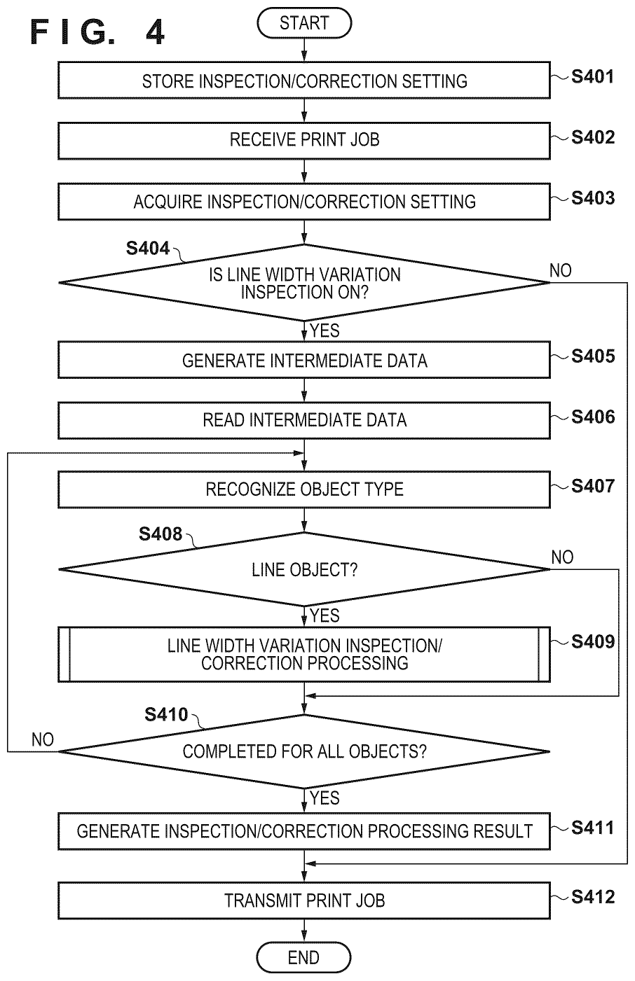

Next, a processing procedure by the information processing apparatus 120 according to the present embodiment will be described, referring to FIG. 4. The processing described below is realized, for example, by the CPU 121 reading, into the RAM 122, and executing a program stored in the ROM 123 or the storage apparatus 125.

At S401, the CPU 121 receives the inspection setting from the operator PC 110 via the network I/F 124 and stores the inspection setting in the storage apparatus 125. The inspection setting includes, for example, inspection ON/OFF setting, a value of the line width to be inspected, or the like. Subsequently, at S402, the CPU 121 receives the print job from the purchaser PC 100 via the network I/F 124 and stores the print job in the storage apparatus 125. The print job includes PDF data, which is the input data.

At S403, the CPU 121 acquires a setting related to inspection and correction from the storage apparatus 125. Subsequently, at S404, the CPU 121 analyzes the setting related to the inspection and correction acquired at S403, and determines whether or not the setting of line width variation inspection is ON. When the inspection setting is ON, the processing proceeds to S405, otherwise the processing proceeds to S412.

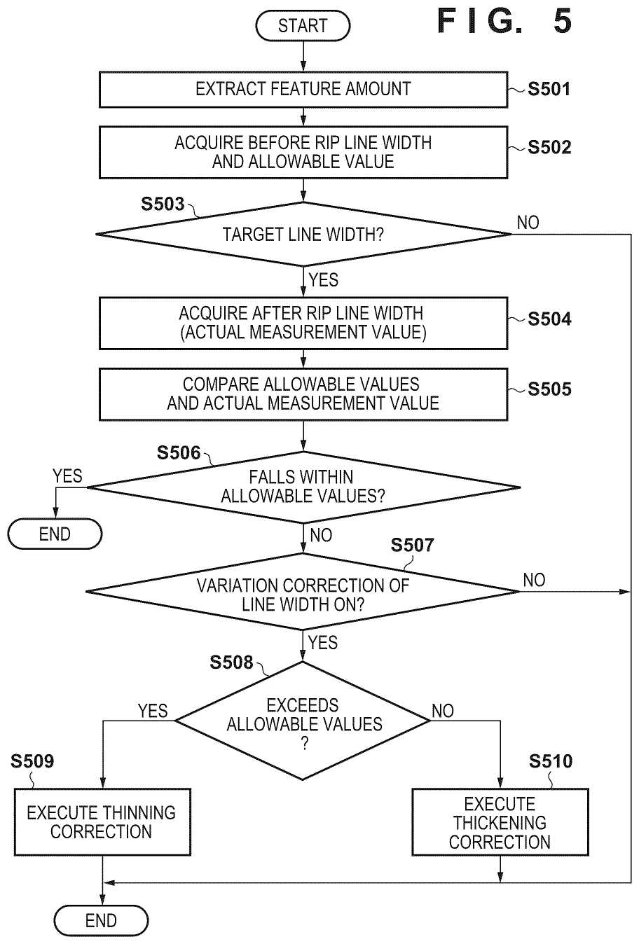

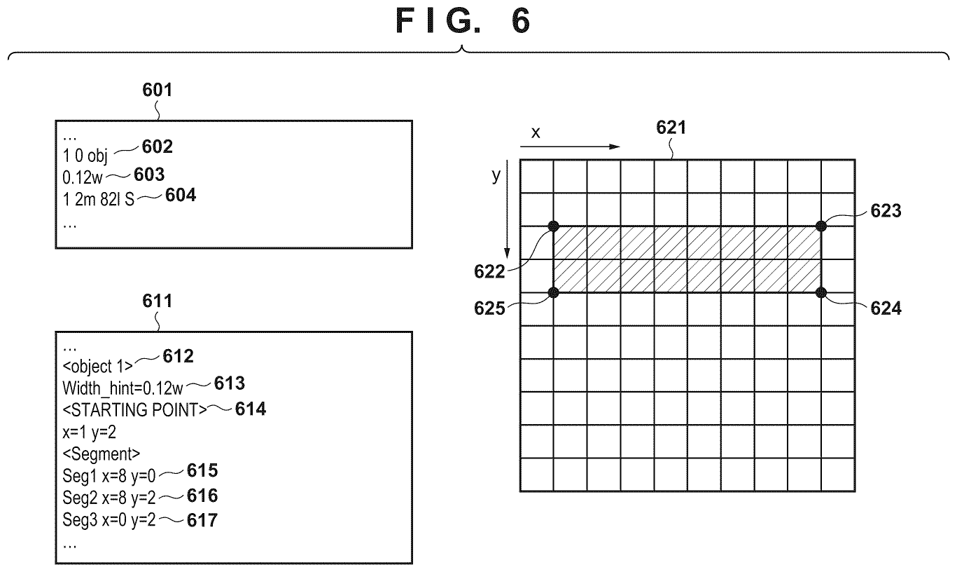

At S405, the CPU 121 analyzes the print job acquired at S402 and generates intermediate data. Here, the intermediate data is the data including a command for displaying a result for a bitmap. Details of the intermediate data will be described below, referring to FIG. 6. At S406, the CPU 121 reads the intermediate data generated at S405. Subsequently, at S407, the CPU 121 recognizes the object type of each object included in the intermediate data. Subsequently, at S408, the CPU 121 determines the object type recognized at S407. When the object type is a line object, the processing proceeds to S409, otherwise the processing proceeds to S410. At S409, the CPU 121 executes the line width variation inspection and correction processing, and the processing proceeds to S410. The processing at S409 will be described in detail below, referring to FIG. 5.

At S410, the CPU 121 determines whether or not processing of all the objects included in the print job is completed, and when all the objects are completed, the processing proceeds to S411, otherwise the processing returns to S407. At S411, the CPU 121 performs RIP processing based on the intermediate data subjected to the inspection and correction processing at S409, and generates a result of the inspection and correction processing. Subsequently, at S412, the CPU 121 transmits a print job to the image forming apparatus 130 via the network I/F 124, and the processing of the current flowchart is terminated.

Here, an example of performing inspection and correction in an object by object basis has been described in the flowchart of FIG. 4. However, the present invention is not limited thereto and inspection and correction may be performed by comparing a plurality of objects in each page, for example. Note that the object by object basis is preferred in terms of memory resource compared to the case of comparing objects, because inspection and correction can be performed with deleting feature amounts that have been acquired and stored.

### <Line Width Variation Inspection and Correction Processing (S409)>

Next, details of the processing procedure of the line width variation inspection and correction processing (S409) in the present embodiment will be described, referring to FIG. 5. The processing described below is realized, for example, by the CPU 121 reading, into the RAM 122, and executing a program stored in the ROM 123 or the storage apparatus 125.

At S501, the CPU 121 analyzes the intermediate data acquired at S406 and extracts a feature amount. The feature amount, which is a piece of information required for performing inspection, includes parameters indicating the width and coordinates of a line, for example. At S502, the CPU 121 acquires, based on the feature amount extracted at S501, a line width and allowable values before the RIP processing is performed. Here, the allowable value refers to a value that allows variation of the line width after image processing (here, after the RIP processing). In other words, when the variation is within the allowable values, the correction processing is not executed. At S503, the CPU 121 analyzes the line width of before RIP processing acquired at S502 and the setting related to the inspection and correction acquired at S403. Specifically, when the line width of before RIP processing is equal to or lower than the target line width, the processing proceeds to S504, otherwise the processing of the current flowchart is terminated.

At S504, the CPU 121 acquires a line width (actual measurement value) after RIP processing based on the feature amount extracted at S501. Subsequently, at S505, the CPU 121 compares the allowable values acquired at S502 and the actual measurement value acquired at S504. At S506, the CPU 121 determines whether or not the actual measurement value falls within the allowable values, based on the result of the comparison at S505. When the actual measurement value falls within the allowable values, the processing of the current flowchart is terminated. When the actual measurement value does not fall within the allowable values, the processing proceeds to S507.

At S507, the CPU 121 analyzes the setting related to the inspection and correction acquired at S403, and determines whether or not setting of the line width variation correction is ON. When the setting is ON, the processing proceeds to S508, otherwise the processing of the current flowchart is terminated. At S508, the CPU 121 determines whether or not the actual measurement value exceeds the allowable values, based on the result of the comparison at S505. When the actual measurement value exceeds the allowable values, the processing proceeds to S509, when the actual measurement value does not exceed the allowable values the processing proceeds to S510. At S509, the CPU 121 executes thinning processing on the line object determined at S408, and the processing of the current flowchart is terminated. On the other hand, the CPU 121 executes, at S510, thickening processing on the line object determined at S408, and the processing of the current flowchart is terminated.

An example of a case of extracting a feature amount from the intermediate data has been described, it is not intended to limit the present invention thereto and the feature amount may be extracted from the print job acquired at S402, for example.

### <Configuration of PDF Data, Configuration of Intermediate Data, and Display Example of RIP Data>

Next, a configuration of PDF data, a configuration of intermediate data, and a display example of RIP data according to the present embodiment will be described, referring to FIG. 6. Reference numeral 601 indicates a configuration example of PDF data. A command 602 indicates an object number and a generation number, and in the example of FIG. 6, the object number is 1 and the generation number is 0. A command 603 indicates a line width, which is 0.12, for example. A command 604 indicates a construction instruction and a drawing instruction of a line. The command 604 is an instruction to construct and draw a line with (x, y)=(1, 2) being start point coordinates and (x, y)=(8, 2) being end coordinates.

Reference numeral 611 indicates a configuration example of the intermediate data generated based on the PDF command configuration example 601. A command 612 indicates a number of an object, which is 1, for example. A command 613 indicates a line width, which is 0.12, for example. Here, although the command 613 is not required for drawing for a bitmap, it is added in generation of intermediate data as hint information required for inspection. A command 614 indicates the start point coordinates of the drawing, which are (x, y)=(1, 2), for example. Commands 615, 616 and 617 each indicate coordinates for configuring an object, the three coordinates being (x, y)=(8, 0), (x, y)=(8, 2), and (x, y)=(0, 2), for example. As such, the intermediate data include parameters for each object included in the input data (PDF data). In addition, the parameters include, for example, a line width of the line object and a plurality of coordinates forming the object including the start point coordinates. In the aforementioned example, the commands 615, 616 and 617 indicate coordinates of boundary points which are the four corners of the line object.

Reference numeral 621 indicates an example of a RIP processing result generated based on the configuration 611 of the intermediate data. Coordinates 622 indicate start point coordinates, which are (x, y)=(1, 2). Coordinates 623 indicate (command 614+command 615), which is (x, y)=(9, 2). Coordinates 624 indicate (command 614+command 616), which is (x, y)=(9, 4). Coordinates 625 indicate (command 614+command 617), which is (x, y)=(1, 4). A region (shaded region) surrounded by the coordinates 622 to 625 indicates a line object to be drawn.

Here, a line object in the horizontal direction is described as an example. However, objects included in the image data may include a line object formed in the vertical direction or a diagonal direction. Particularly for a diagonal line object, variation of the line width is likely to occur after the RIP processing. The reason is that all the pixels included by the line object are drawn. For example, the line object may lie within a single pixel or extend across two pixels, depending on the drawing position, and in such a case, variation of the line width may occur.

### <Method of Acquiring Line Width of Before RIP Processing, Allowable Value, and Actual Measurement Value>

Here, the line width of before RIP (dot) can be acquired by (dpi)*(w/72), where w is the line width in the command 612 and dpi is the resolution after RIP. The value of the allowable value can be set as a line width of before RIP±an arbitrary value. For example, assuming that the line width w is 0.12 and the resolution dpi is 1200, the line width of before RIP is 2 dots. Assuming that the allowable values are ±0.5 dots, the allowable values have a lower limit value of 1.5 and an upper limit value of 2.5 dots. In other words, the present embodiment determines the allowable values based on the line width of before RIP processing. When the line width of after RIP processing falls below the lower limit value of the allowable values, thickening processing is applied to the line object. When, on the other hand, the line width of after RIP processing exceeds the upper limit value of the allowable values, thinning processing is applied to the line object.

The actual measurement value is determined based on the intermediate data such that two line segments each located between two coordinates, distance of which is longest, are extracted, and line width that is a vertical component between the two line segments is used as the actual measurement value. In the case of 621, a line segment from the coordinates 622 to the coordinates 623 and a line segment between the coordinates 624 and the coordinates 625 are the two line segments. The line width that is the vertical components of 2 dots between the two line segments is determined as the actual measurement value. Here, acquisition of the line width of before RIP, the allowable values, and the actual measurement value described above is merely an example and other methods may be used.

### <Line Width Variation Correction>

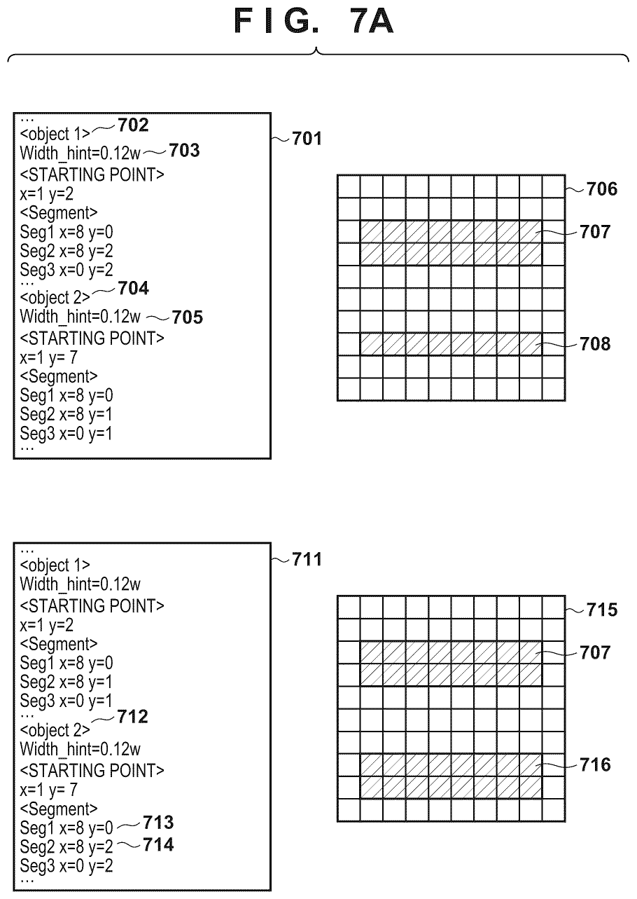

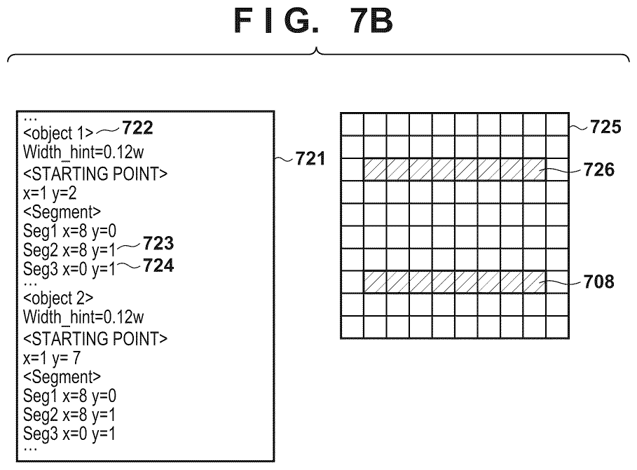

Next, line width variation correction in the present embodiment will be described, referring to FIGS. 7A-7B. A configuration 701 of the intermediate data and image data 706 before the correction processing are respectively illustrated. Here, the image data 706 indicates a result of RIP processing using the configuration 701 of the intermediate data. Since details of each command of the configuration 701 of the intermediate data have been described in the configuration 611 of the intermediate data, description thereof will be omitted. Here, image data 707 and image data 708 are results of output respectively based on the command group 702 indicating the object number 1 and the command group 704 indicating the object number 2. Here, when respective line widths 703 and 705 of the object numbers 702 and 704 are compared, it can be seen that the line widths are the same, whereas the image data 707 and 708 have different output results.

Reference numeral 711 indicates a configuration of the intermediate data in a case where thickening correction is performed based on the RIP processing result of 706. Here, an example of performing the thickening processing in a case where the image data 708 is determined to be out of the allowable range in the RIP processing result 706 is illustrated. Reference numeral 715 indicates image data of the result of RIP processing using the configuration 711 of the intermediate data. Image data 716 is a result of an output based on the command group of the command 712 indicating the object number 2. By using thickening correction, the image 716 that is thickened by 1 dot in the y-axis direction can be obtained by incrementing, by 1 in the y-axis direction, the coordinates 713 and 714 forming the object.

Reference numeral 721 indicates a configuration of the intermediate data in a case where thinning correction is performed based on the RIP processing result of 706. Here, an example of performing the thinning processing in a case where the image data 707 is determined to be out of the allowable range in the RIP processing result 706 is illustrated. Reference numeral 725 indicates image data of the result of RIP processing using the configuration 721 of the intermediate data. Image data 726 is a result of an output based on the command group of the command 722 indicating the object number 1. By using thinning correction, the image 726 that is thinned by 1 dot in the y-axis direction can be obtained by decrementing, by 1 in the y-axis direction, the coordinates 723 and 724 forming the object.

The line width variation correction described here is merely an example, and thinning correction or thickening correction may be performed using other methods or criteria. For example, the correction processing may be performed on image data not by a command-by-command basis.

### <Inspection/Correction Result Screen Example>

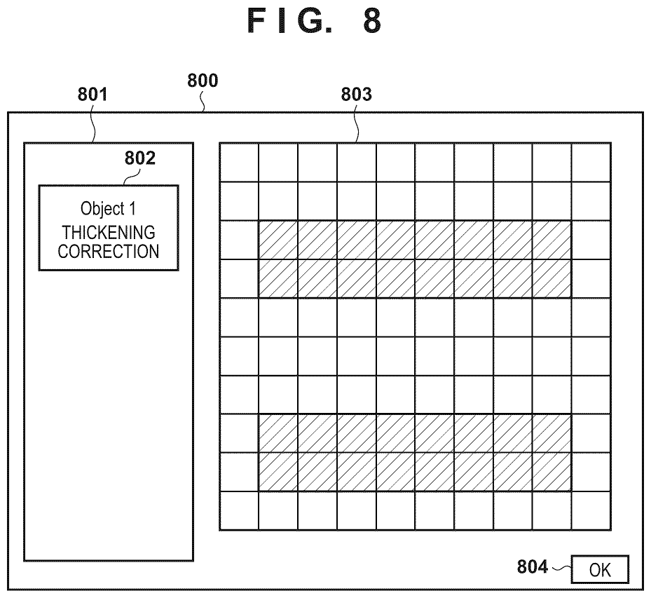

Next, an example of the inspection/correction result screen in the present embodiment will be described, referring to FIG. 8. A display screen 800 of FIG. 8 is a screen displayed on the display unit of the operator PC 110. Inspection/correction processing contents 801 and image data 803 that is the result of RIP processing are respectively displayed in the display screen 800. An item 802 included in the inspection/correction processing contents 801 indicates details of the inspection/correction result. In the example of FIG. 8, display indicates that the object number 1 came out to be inspection NG and then the thickening correction is performed. In other words, in the inspection/correction processing contents 801, information indicating the object of inspection NG, and contents of the correction processing being applied are displayed. A single item is displayed in this example, however when a plurality of objects came out to be inspection NG, a same number of items as the objects are displayed. When there is no object came out to be inspection NG, that is also displayed. In addition, after having checked the inspection/correction result, a user can press an OK button 804 to close the screen being displayed. Here, the display screen 800 of FIG. 8 is merely an example, and there may be other display contents.

In addition, in the image data 803, the line object to which the correction processing is executed may be highlighted. In highlighting, the line width before correction and the line width after correction may be displayed in a distinguishable manner. For example, in addition to the line width before correction, the line width after correction may be displayed in a different color. In such a case, the line width before correction and the line width after correction can be simultaneously checked by drawing the line width after correction in a translucent color or the like. Here an example of displaying, on the display unit, the results with regard to inspection and correction of the line width has been described here, it is not intended to limit the present invention thereto. For example, an image corresponding to the result screen may be printed out, or data including information of the result may be transmitted to an external apparatus via a network.

As has been described above, the information processing apparatus according to the present embodiment inspects line width of an object included in print data after image processing is applied on input data for printing. In addition, the information processing apparatus corrects the line width of the object based on the inspection result. For example, in the aforementioned embodiment, the line object is inspected at S505 of FIG. 5, and the correction processing of the line object is executed at S509 and S510. As has been described above, the present embodiment allows for appropriately inspecting variation of the line width after image processing is applied on input data. Therefore, a problem in the line, which may be overlooked in the inspection and will be revealed in subsequent processing, can be preliminarily detected and corrected, thereby waste paper or rework time can be reduced.

### Variation Example

The present invention is not limited to the embodiments described above, and various modifications can be made. For example, inspection and correction processing of the line width for the line object included in the image data have been described in the aforementioned embodiment. However, the present invention is not limited thereto and can be applied for an object including lines such as character objects or graphic objects. In such a case, it is desirable to make the target line width to be specifiable for each type of object in the setting screen 300 of FIG. 3, for example. In addition, when inspection and correction of the line width are performed on an object other than line objects, the type of object may be determined at S408, and the processing may branch to the inspection and correction processing of each object.

In addition, a case has been described in the aforementioned embodiment, in which variation of the line width is inspected and when the inspection comes out to be NG, correction is performed. However, a case in which only inspection is ON and correction is OFF in the setting screen 300 of FIG. 3 may also be conceivable. For such a case, whether or not to execute the correction processing of the object of inspection NG may be made to be selectable, in the inspection result screen indicating that the inspection came out to be NG. In such a case, whether or not to perform correction for each object of inspection NG may also be made to be selectable.

### Other Embodiments

The present invention can be implemented by processing of supplying a program for implementing one or more functions of the above-described embodiments to a system or apparatus via a network or storage medium, and causing one or more processors in the computer of the system or apparatus to read out and execute the program. The present invention can also be implemented by a circuit (for example, an ASIC) for implementing one or more functions.

The present invention is not limited to the above embodiments and various changes and modifications can be made within the spirit and scope of the present invention. Therefore, to apprise the public of the scope of the present invention, the following claims are made.

According to the present invention, it is possible to appropriately inspect variation of the line width after image processing is applied on input data. Therefore, a problem in the line, which will be revealed in subsequent processing, can be preliminarily detected and corrected before print-out, thereby waste paper or rework time can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-195863 filed on Dec. 7, 2022, which is hereby incorporated by reference herein in its entirety.

What is claimed is:

1. An information processing apparatus comprising:
at least one memory device that stores a set of instructions; and
at least one processor that executes the set of instructions to:
inspect a line width of an object included in print data after image processing is applied on input data for printing, and
correct a line width of the object based on an inspection result.

2. The information processing apparatus according to claim 1, wherein the at least one processor executes instructions in the memory device to:
determine, from the line width of the object in the input data, an allowable value of the line width after the image processing is applied, and
inspect variation of the line width in the object after the image processing, by comparing an actual measurement value of the line width in the object after the image processing and the allowable value.

3. The information processing apparatus according to claim 2, wherein the at least one processor executes instructions in the memory device to thicken or thin the line width of the object after the image processing, making the line width to fall within a range of the allowable values, in a case where the actual measurement value does not fall within the range of the allowable values.

4. The information processing apparatus according to claim 2, wherein the at least one processor executes instructions in the memory device to generate, from the input data, intermediate data for each object included in an image, and determine the allowable value from parameters relating to line width and coordinates included in the intermediate data.

5. The information processing apparatus according to claim 1, wherein
the at least one processor executes instructions in the memory device to:
perform, by user input via a setting screen, setting related to inspection and correction of the line width, and
make inspection and correction of the line width being allowed to be respectively set in the setting screen to be enabled or disabled.

6. The information processing apparatus according to claim 5, wherein the at least one processor executes instructions in the memory device to further allow, in the setting screen, a line width that is a processing target to be specified.

7. The information processing apparatus according to claim 6, wherein the at least one processor executes instructions in the memory device to further allow, in the setting screen, inspection and correction of the line width to be respectively set for each type of object.

8. The information processing apparatus according to claim 1, wherein the at least one processor executes instructions in the memory device to output a result relating to inspection and correction of the line width.

9. The information processing apparatus according to claim 1, wherein the image processing is RIP processing.

10. A control method for an information processing apparatus, comprising:
inspecting a line width of an object included in print data after image processing is applied on input data for printing; and
correcting a line width of the object based on an inspection result.

11. A non-transitory computer-readable storage medium storing a computer program for causing a computer to execute each step in a control method of an information processing apparatus, the control method comprising:
inspecting a line width of an object included in print data after image processing is applied on input data for printing; and
correcting a line width of the object based on an inspection result by the inspecting.
